(19) United States
(12) Patent Application Publication
(10) Pub. No.: US 2018/0330409 A1
(43) Pub. Date: Nov. 15, 2018

(54) SYSTEM OF RAISING FUNDS THROUGH AN AUCTION PROCESS

(71) Applicant: David V. Majzner, Apple Valley, MN (US)

(72) Inventor: David V Majzner, Apple Valley, MN (US)

(21) Appl. No.: 15/942,844

(22) Filed: Apr. 2, 2018

Related U.S. Application Data
(60) Provisional application No. 62/154,097, filed on Apr. 28, 2015.

(51) Int. Cl. G06Q 30/02; G06Q 30/08

(52) U.S. Cl. CPC G06Q 30/0279; G06Q 30/08

(57) ABSTRACT

A computer enabled system using an embedded software program for enabling business partners and business professionals to directly assist non-profits, schools and charities in continuous fundraising which avoids fundraising fatigue typically experienced by donors in fundraising systems. The invention taught herein provides the advantage in the market of a computer enabled system that utilizes the result of round-up programs in conjunction with the speed and convenience of online auctioning of donated items for the raising and collection of funds for a charitable organization while keeping corporate or retail donors motivated to continuously participate in fundraising activities.

### CLAIM OF PRIORITY

This application claims priority to and the benefit of U.S. Provisional Patent Application No. 62/514,097, filed Jun. 2, 2017 and entitled “SYSTEM OF RAISING FUNDS THROUGH AN AUCTION PROCESS” the application of which is incorporated herein by reference in its entirety.

### BACKGROUND AND FIELD OF INVENTION

The invention relates generally to online auction systems and software.

Auction sites such as eBay, eBid and others typically act as an intermediary between a seller of product(s) and one or more purchasers interested in purchasing the product at a discount. The intermediary, in this case, usually charges a transaction or service fee for use of the auction site and for payment processing, which may be charged to both parties to the transaction.

In the segment of the market of raising funds for charitable organizations, donating companies or merchant partners usually have to partner with the charity to collect donations at the site of the donor company or retail establishment, such as a grocery store or restaurant, at the time of the purchasing transaction. The funds collected by the participating store or restaurant or retailer are then tendered to the charity at the end of the fund drive with little financial benefit to the corporate partner other than an altruistic recognition by the community or the charity. In some cases retailers start to experience “fundraising fatigue” as they are constantly being solicited for donations with little return on their investment in terms of revenue or additional foot traffic to their brick and mortar establishments.

Some of these fundraising systems have been automated by using coupons or gift cards that can be auctioned off for the benefit of the charity, however in both cases that corporate sponsor/donor has to wire the collected funds or provide coupons/gift cards to the auctioneer with little to no financial benefit or motivation to the corporate donor/partner. Therefore, there is a need in the market for a system that utilizes the speed and convenience of an online fundraising process for the fundraising and collection of funds for a charitable organization that provides additional benefits and motivation to corporate or retail donors to participate in the fundraising process more actively and continuously.

### SUMMARY

A computer enabled system using an embedded software program for enabling business partners and business professionals to directly assist non-profits, schools and charities in continuous fundraising which avoids fundraising fatigue typically experienced by donors in fundraising systems. The invention taught herein provides the advantage in the market of a computer enabled system that utilizes the result of round-up programs in conjunction with the speed and convenience of online auctioning of donated items for the raising and collection of funds for a charitable organization while keeping corporate or retail donors motivated to continuously participate in fundraising activities. In particular, a corporate donor and a charity work with an Auction Manager to collect donated funds via a website and convert them into redeemable certificates. This novel system provides a financial incentive to the corporate donor to maximize donations from patrons, part of which become income to the corporate donor, provides marketing for the corporate donor and increases traffic for the corporate donor upon the certificates being redeemed.

In one example embodiment, computer-implemented method is provided for increasing revenue for a merchant retailer or business partner while participating in a fundraising program for a nonprofit organization or cause. The method includes the steps of receiving, at a first computer system, from a plurality of customers a monetary contribution for at least one nonprofit organization, thereby generating a monetary contribution amount from a merchant retailer or business partner sponsored fundraising activity for a predefined time period. The next step of the method includes providing a matching monetary contribution by the merchant retailer, with the first computer system, of the monetary contribution amount thereby generating a total monetary contribution amount, wherein the matching monetary contribution is a predefined merchant percentage amount of the monetary contribution amount. Next the method provides for receiving by an auction manager, at a second computer system, the total monetary contribution amount from the merchant retailer and using the second computer system to post redeemable certificates on an online auction website hosted by the second computer system, where the redeemable certificates comprise predefined individual units of the total monetary contribution amount and are redeemable with the merchant retailer. The method also includes the step of conducting, with the second computer system, an online auction of the redeemable certificates and processing payments by a bidder for the redeemable certificates through a payment processing module enabled by the second computer system and then the step of generating, with the second computer system, a redemption code specific to each merchant retailer redeemable certificate, the redemption code expiring upon one of a first use or a predefined time period. Finally, the method includes the step of transmitting, by the second computer system through the payment processing module, to the nonprofit organization a predefined percentage of funds received from purchases of the redeemable certificates. In a related embodiment, the business partner sponsored activity includes a roundup activity as a process for gathering monetary contributions from the plurality of customers.

In a related embodiment, in the step of receiving by an auction manager, at a second computer system, the total monetary contribution amount from the merchant retailer the method also includes using the second computer system to post discounted redeemable certificates on an online website hosted by the second computer system, and then conducting, with the second computer system, an online sale of the discounted redeemable certificates and processing payments by the bidder for the discounted redeemable certificates through the payment processing module enabled by the second computer system.

In another example embodiment, a computer enabled system is provided for increasing revenue for a merchant retailer or business partner while participating in a fundraising program for a nonprofit organization or cause, the system including a nonprofit database for storing information associated with nonprofit organizations and a merchant retailer or business partner database for storing information associated with business partners. The system also includes a merchandise database for storing information associated with at least one of: redeemable certificates or merchandise uploaded by a merchant retailer or business partner to be sold online via a website hosted on a dedicated computer server system; and a set of redeemable certificates pre-associated with a selected nonprofit having a monetary value that includes a monetary matching component from the business partner. The system further includes a communications module in the dedicated computer server configured to electronically communicate with at least the merchandise and the nonprofit databases and send to a purchaser the information associated with the certificates or merchandise to be sold and the information associated with the nonprofit organization. The system further includes a redemption code module configured to generate a redemption code specific to each merchant retailer redeemable certificate, the redemption code expiring upon one of a first use or a predefined time period Finally, the system includes a payment processing module in the dedicated server for receiving, from a purchaser, an offer to purchase the redeemable certificate, or merchandise, and for transmitting a predefined percentage of funds received from purchases of the redeemable certificates to the selected nonprofit organization.

In yet another example embodiment, a computer-implemented method is provided for creating individual fundraising campaigns for a nonprofit organization or cause by a nonprofit member or a nonprofit supporter, the method including the step of registering a nonprofit organization or a cause through a login module communicatively coupled to a pledge module and a nonprofit database hosted by and using a dedicated computer server system as a recipient of funds raised in a fundraising campaign. The method also includes the step of registering a pledge recipient through the login module, the pledge module and the nonprofit database using the dedicated computer server, where the pledge recipient defines the fundraising campaign metrics to include: a fundraising target, a measurable redeemable unit or a performance goal to be completed by the pledge recipient, optionally a fixed monetary donation for the performance goal completion, an expiration date of the fundraising campaign and a monetary value per redeemable unit completed, where upon completion of the performance goal at least one supporter provides a monetary contribution to the nonprofit on behalf of the pledge recipient. The method further includes registering at least one supporter of the pledge recipient through the login module, the pledge module and the nonprofit database using the dedicated computer server, the supporter inputting payment processing information in a payment processing module enabled by the dedicated computer server. Next the method involves notifying at least one supporter through the dedicated server of the pledge recipient progress towards completing one of: the performance goal and a number of measurable redeemable units. Finally, the method includes the step of transmitting to the nonprofit organization or cause, by the dedicated computer server system through the payment processing module, a predefined percentage of funds received from the supporter in connection with the notification of completion of the performance goal or expiration of the individual pledge fundraising campaign.

In yet another example embodiment, a system is provided for assisting non-profits and charities in fundraising when partnering with corporate donors or local community businesses. In particular, the first step is a corporate donor/business enrolls in Bid Auction program and selects charity or Non-Profit. The Corporate Donor/Business then collects donations for selected charity. The Corporate Donor/Business then reports to Auction Manager the total funds collected which includes a Matching Component and the combined funds are converted into redeemable certificates. The Corporate Donor then uses Auction Manager's website to upload certificates to the website and conducts an auction of certificates. The Auction Manager then collects a service fee from funds received for website sale of certificates. The Auction Manager then sends the balance of proceeds to the non-profit/charity. Finally, the certificate buyers then go to the Corporate Donor/Business to spend or redeem the certificates purchased online.

In a related embodiment, the fundraising system described above is not necessarily limited to non-profits but is applicable to other situations where funds need to be raised, such as for a new venture or start up, and the Auction Manager is used for a more secure form of crowdfunding. The Auction Manager is motivated to find funds for the new venture due to the service fee or commission structure and there are multiple “donor partners” instead of one corporate donor partner.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 is an example embodiment of a workflow diagram of a fundraising system for nonprofits primarily focused on business/merchant partners or business professionals offering services as key drivers in the system according to the teachings of the invention.

FIG. 2 is a diagram of an example embodiment of a fundraising server system which includes an auction module, an eCommerce store module, an individual/team pledging module and an optional gamification module according to the teachings of the invention.

FIG. 3 illustrates a flowchart describing a process flow of using a fundraising system and website for purchasing merchandise providing both an auction and a non-auction option, a portion of the purchase proceeds of which will be for the benefit of a nonprofit or third-party organization according to the teachings herein.

FIG. 4 illustrates a flowchart describing a process flow of using an auction module of a fundraising system and website for raising funds for the benefit of a nonprofit or third-party organization according to the teachings herein.

FIG. 5 is flowchart describing a process flow of novel self-defined pledge funding module of the fundraising system described herein for use in raising funds for the benefit of a third-party organization according to the teachings herein.

FIGS. 6A-6C are illustrations of screenshots of a smartphone or smart device exhibiting a fundraising software applet configured to communicate with the fundraising system described herein.

FIG. 7 is a screenshot of a business partner's donation page including donated item details and the identification of various nonprofits as potential beneficiaries of the fundraising system described herein.

FIG. 8 is a screenshot of a summary of a particular bidder's page on the fundraising system.

FIG. 9 is a screenshot of Users/Members, Business Partners and Nonprofits active on the fundraising site and system.

### DESCRIPTION OF THE PREFERRED EMBODIMENTS

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

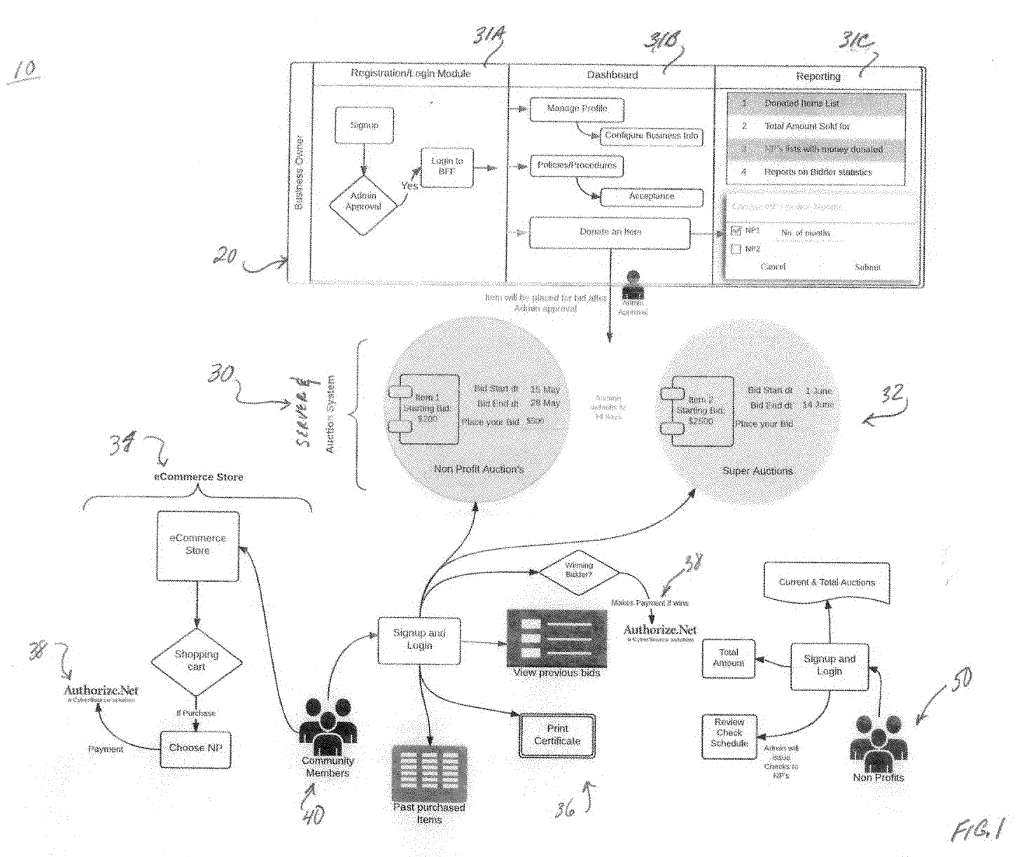

Referring now to the figures, FIG. 1 illustrates an example embodiment of a workflow diagram of a fundraising system 10 for nonprofits primarily focused on business/merchant partners or business professionals offering services as key drivers in the fundraising system according to the teachings of the invention. In particular, system 10 includes business partners 20, community members or bidders 40 and nonprofits 50 all which interface with a fundraising computer server 30 that includes an online auction system 32, an eCommerce module 34, a bid tracking system 36 and a payment processing system 38. In this example embodiment, business partners or merchant retailers 20 eventually provide merchandise or redeemable certificates to server 30 which can either be sold through auction system 32 or eCommerce store 34 when the items on posted online. One of the unique features of the example embodiment is that business partners 20 provide the items for sale or auction through business partner-sponsored fundraising activities, such as roundups or voluntary donations provided by nonprofits supporters attending the fundraising event, the funds of which are then partially matched (e.g. 25% of total collected) by business partners 20 and then the total amount is converted into redeemable certificates (or gift cards) or merchandise items. The redeemable certificates or merchandise items are then uploaded through the fundraising server system 30.

At the start of the fundraising campaign or fundraising process using the Bid For Funds™ (BFF) fundraising platform, business partners login through module 31A and provide identifying information about their respective businesses and create a profile through a dashboard module 31B. Donated items from business partners 20 resulting from the business partner sponsored activity and matching system are then uploaded into server 30 and tracked through reporting module 31C. The primary benefit to business partners 20 using the auction process 32 to sell their redeemable certificates is the constant exposure of their brand and the breadth of their participation with the various nonprofits that they support to the many visitors to the BFF website and platform. Bidders 40, which can be nonprofit supporters or community members at large have the choice of participating in the auction for goods and certificates (through a bidding process 36) or can go directly to eCommerce store option 34 and buy items at a discount or for a “buy it now” price.

Finally, nonprofits, including schools, churches, social assistance organizations and clubs 50 are the beneficiaries of sales of the items through system 10 and server 30. Once items are sold either through auctions 32 or store 34, the payment is processed through payment processing 38 and then a high percentage of the proceeds are transmitted directly to nonprofits 50.

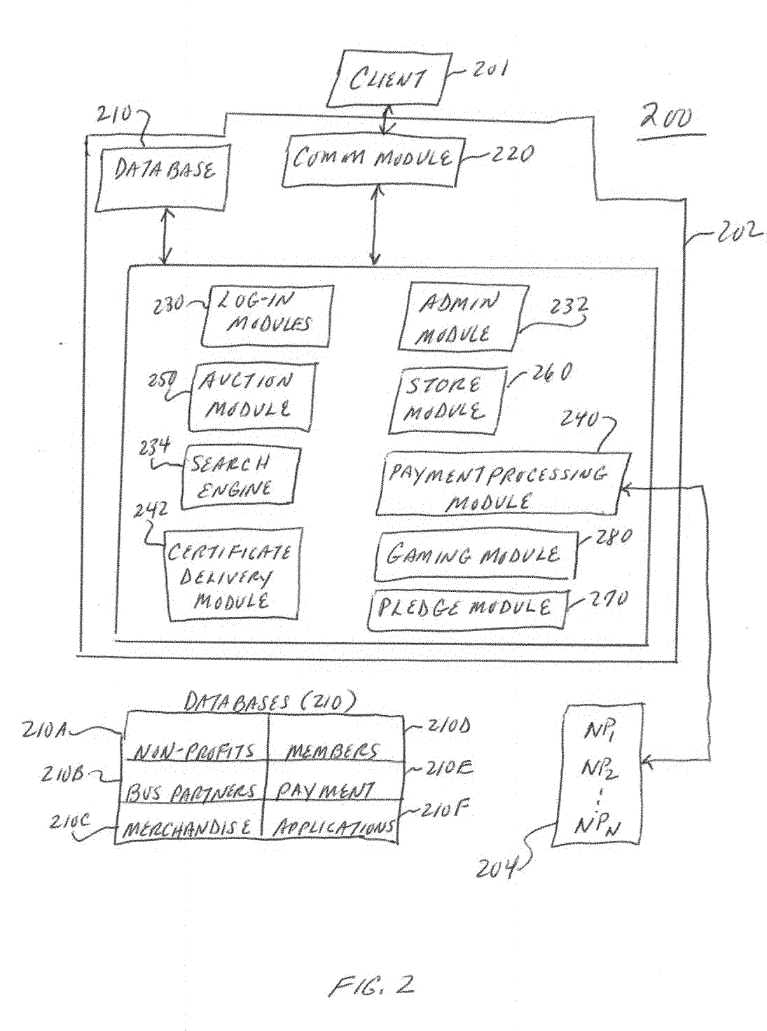

Referring now to FIG. 2, there is illustrated a diagram of an example embodiment of a fundraising server system 200 which is configured to communicate to a client/bidder or customer 201 that wishes to support a nonprofit 204 through fundraising server system 200 according to the teachings of the invention. In this example embodiment, computer enabled system 200 is provided for increasing revenue for a merchant retailer or business partner while participating in a fundraising program for a nonprofit organization or cause. System includes a series of databases 210, such as, but not limited to, a nonprofits database 210A, a business partners database 210B, a merchandise or certificate database 20C to track donated items, a members/bidders database 210D, a payment database 210E to store payment and credit card details for various participants in system 200 and an applications database 210F. Nonprofit database 210A stores information associated with all kinds of nonprofit organizations, including schools, booster clubs, churches and the like while merchant retailer or business partner database 210B stores information associated with business partners that may be retailers as well as professionals offering services. Merchandise database 210C, in this example embodiment, also includes information associated with redeemable certificates or merchandise uploaded by a merchant retailer or business partner to be sold online via a website hosted on a dedicated computer server system as well as a set of redeemable certificates pre-associated with a selected nonprofit having a monetary value that includes a monetary matching component from the business partner. System 200 further includes a communications module 220 in the dedicated computer server 202 that is programmed to electronically communicate with at least the merchandise and the nonprofit databases and is programmed to send to a purchaser or client 201 the information associated with the redeemable certificates or merchandise to be sold as well as the nonprofit information associated with the certificate. Finally, the system includes a payment processing module 240 in the dedicated server 202 for receiving, from purchaser 201, an offer to purchase the redeemable certificate, or merchandise, and for transmitting a predefined percentage of funds received from purchases of the redeemable certificates to the selected nonprofit organization 204.

In this example embodiment, system 200 further includes an administrative module 232 for managing the back office of system 200 and includes a search engine module 234 for the convenience of searching items that may be needed by the users of system 200. A certificate delivery module 242 is also included to manage how certificates will be delivered or picked up by the winning bidder or purchaser.

In a related embodiment, merchandise database 210C receives from the business partner the set of redeemable certificates originating from a business partner sponsored fundraising activity, wherein the activity includes a roundup activity as a process for gathering monetary contributions from a plurality of customers. In this case, the business partner gathers the monetary contributions and includes a matching portion before converting the entire collected funds into redeemable certificates to be uploaded and sold.

In this example embodiment of system 200, there is also included an auction module 250, for facilitating the sale of donated items via an auctions system and an eCommerce store module 260, to facilitate the quick sale of items for purchasers that do not want to bid for their desired items. Specifically, auction module 250 conducts an online auction with the dedicated server system 202 of the redeemable certificates and processes payments by a bidder 201 for the redeemable certificates through payment processing module 240 enabled by the dedicated computer server system. Store module 260, on the other hand, displays to the purchaser discounted merchandise items and redeemable certificates having a discounted “buy it now” price on the website which is hosted by the dedicated computer server 202, each of the items and certificates displaying indicia indicating pre-association with a selected nonprofit. There is also included in system 200 an individual/team pledging module 270 for customized fundraising campaigns, using the dedicated computer server 202 for generating individual fundraising campaigns for members of the selected nonprofit 204, where the individual fundraising campaign includes: a fundraising target, measurable redeemable units to be completed by a participating nonprofit member, a duration of the fundraising campaign and a process of redeeming the redeemable units with a supporter in exchange for a monetary contribution to the nonprofit.

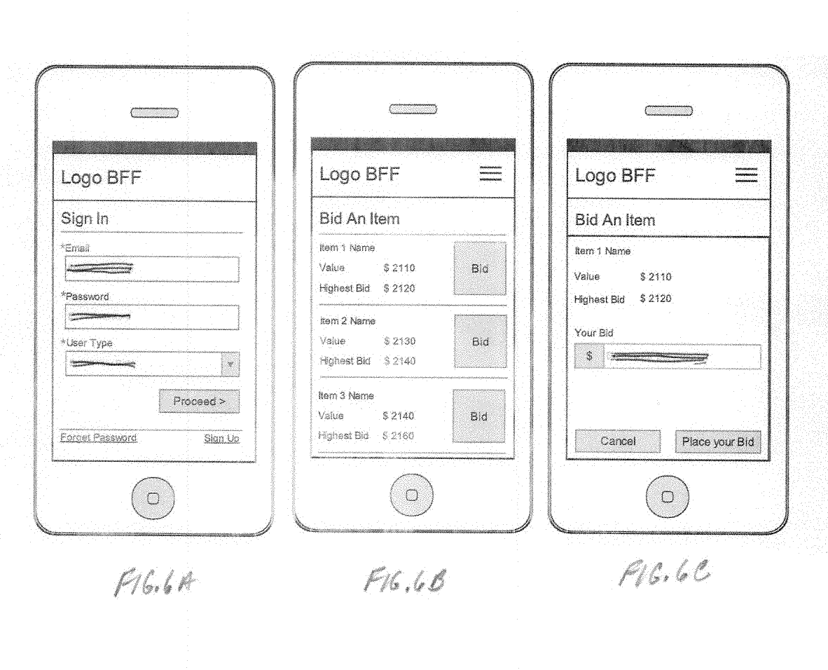

System 200 also includes an optional gamification module 280 which generates game-oriented icons with an associated point value embedded randomly in one of the various website pages, wherein a cumulative value of the associated points by a participant over a predefined time period leads to randomized drawing for redeemable prizes or rewards. In a related embodiment, system 200 includes an associated software applet configured to operate on a portable or mobile smart device (see FIGS. 6A-6C) and programmed to communicate with the communications module of the dedicated computer server, wherein the software applet enables a user to purchase a redeemable certificate and to redeem the certificate from the smart device at the merchant retailer.

In one example method using system 200, where the business partner has his own computer system (for his business establishment) that can communicate with system 200 and is sponsoring a fundraising activity, a computer-implemented method is provided for increasing revenue for a merchant retailer or business partner while participating in a fundraising program for a nonprofit organization or cause. The method includes the steps of receiving, at a first computer system, from a plurality of customers a monetary contribution for at least one nonprofit organization, thereby generating a monetary contribution amount from a merchant retailer or business partner sponsored fundraising activity for a predefined time period. The next step of the method includes providing a matching monetary contribution by the merchant retailer, with the first computer system, of the monetary contribution amount thereby generating a total monetary contribution amount, wherein the matching monetary contribution is a predefined merchant percentage amount of the monetary contribution amount. Next the method provides for receiving by an auction manager, at a second computer system, the total monetary contribution amount from the merchant retailer and using the second computer system to post redeemable certificates on an online auction website hosted by the second computer system, where the redeemable certificates comprise predefined individual units of the total monetary contribution amount and are redeemable with the merchant retailer. The method also includes the step of conducting, with the second computer system, an online auction of the redeemable certificates and processing payments by a bidder for the redeemable certificates through a payment processing module enabled by the second computer system and then the step of transmitting, by the second computer system through the payment processing module, to the nonprofit organization a predefined percentage of funds received from purchases of the redeemable certificates. In a related embodiment, the business partner sponsored activity includes a roundup activity as a process for gathering monetary contributions from the plurality of customers.

In a related embodiment, in the step of receiving by an auction manager, at a second computer system, the total monetary contribution amount from the merchant retailer the method also includes using the second computer system to post discounted redeemable certificates on an online website hosted by the second computer system, and then conducting, with the second computer system, an online sale of the discounted redeemable certificates and processing payments by the bidder for the discounted redeemable certificates through the payment processing module enabled by the second computer system.

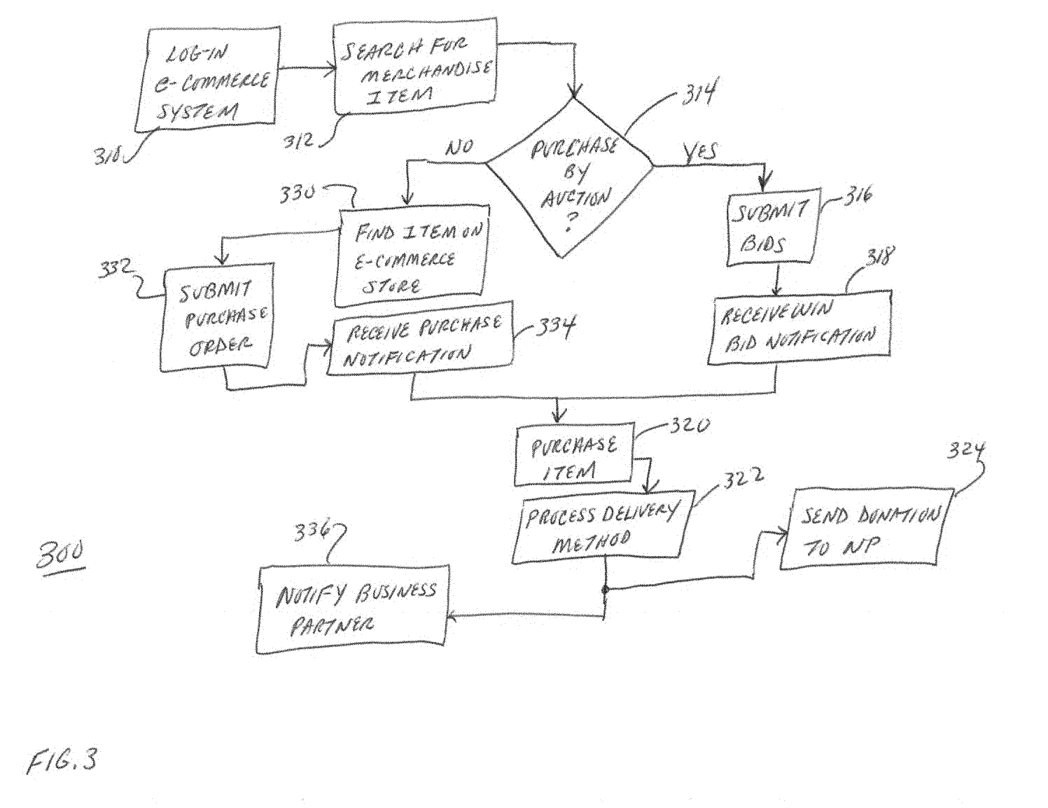

Referring now to FIG. 3, there is illustrated a flowchart describing an example embodiment of a process flow of using a fundraising system and method 300 and a web site for purchasing merchandise using an auction or a non-auction option, a portion of the purchase proceeds of which will be for the benefit of a nonprofit or third-party organization according to the teachings herein. In this example embodiment, a user logs in to the eCommerce system at 310 and then searches at 312 for the desired merchandise item or redeemable certificate. At 314 the user decides whether to purchase the item via an auction or not. If yes, they follow the path to 316 and submit a bid for the item. Once they receive a winning bid notification at 318 they proceed to 320 to purchase the item and then determine at 322 how they will receive delivery (either through electronic certificate or by mail or pick up at the merchant location, which are preprogrammed options by a merchant retailer or a fundraising facilitator). Once the purchase is complete, the majority of the funds from the sale are transmitted to the nonprofit at 324, except for a small portion (about 25%-30%) which is transmitted to fundraising facilitator (e.g., BidForFunds). The business partner or merchant retailer is then notified at 336.

In some instances, the merchant retailer or business partner is a business services provider such as an insurance agent, a realtor, an accountant or an attorney, that wishes to participate but may be prohibited from providing certificates for services by certain states or jurisdictions. The present fundraising platform allows this type of business services partner to participate (and receive marketing exposure) by purchasing and posting at the auction or the eCommerce store a redeemable certificate with a designated nonprofit so as to participate in fundraising system 300 as an “agent”. This path allows the business services “agent” to support the designated nonprofit while indirectly marketing to the nonprofit members and supporters.

If at 314, the purchaser chooses to not participate in an auction and instead desires to purchase the desired item, the purchaser/user searches for the item at 330 at the eCommerce store. After finding the item, they submit a purchase order at 332 and then they receive purchase notification that their offer has been accepted and then the item is purchased and payment is processed at 320. The process then continues as described above.

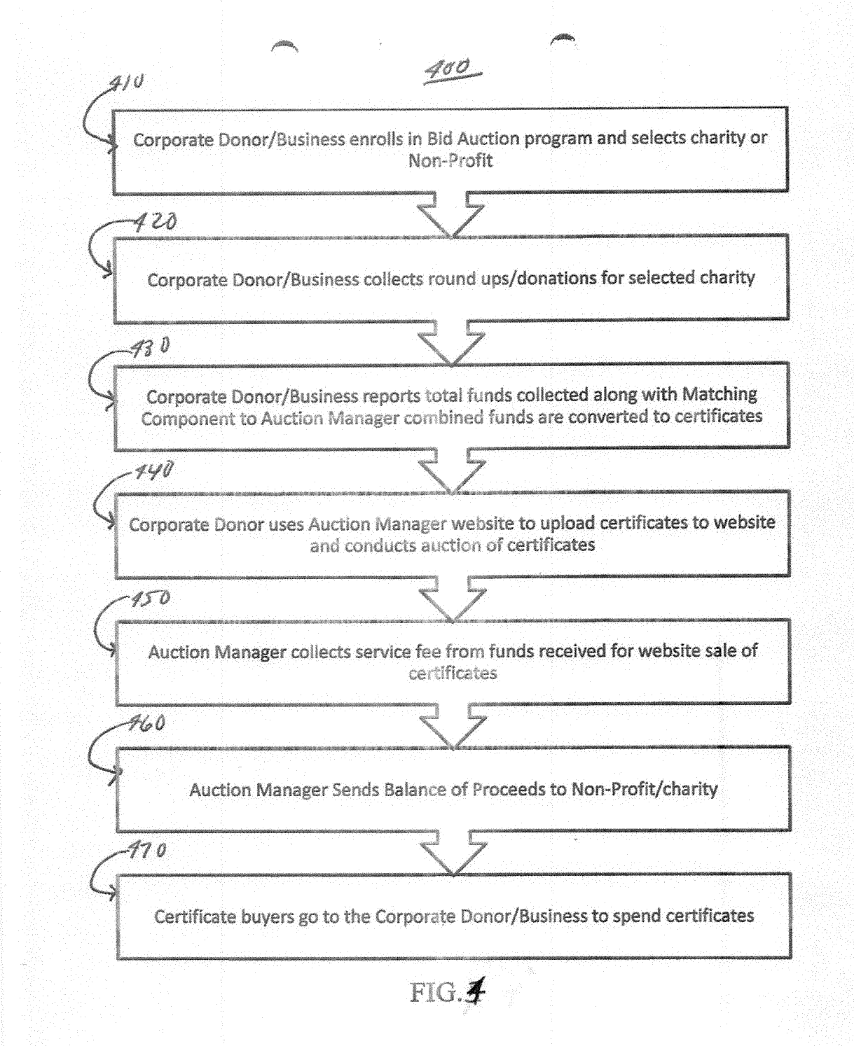

Referring now to FIG. 4, there is illustrated a flowchart 400 of another example embodiment of a fundraising system using an auction website and redeemable certificates, such as but not limited to, coupons, gift cards, paper certificates and the like. In this example embodiment, a first step of 410, a corporate donor or partner enrolls in an Auction Manager's auction program and selects a charity that the Donor wishes to support. Interim steps to enrolling may include: feasibility test to verify production capability for business; ability of business to participate (will/can they commit to program due to some legal or policy restrictions); taking a sign-up fee from the merchant retailer or business partner; or sign commitment contract/non-compete agreement with the corporate donor. Other items prior to launching the business partner program includes providing the donor/business with promotional materials or enrolling donor/business on website. Working through welcome packet to familiarize donor/business with website and process as well as developing or acquiring marketing information for their page on the site or training staff on sales and marketing for donations and program execution.

In the next step 420, the corporate donor collects or rounds up donations for selected non-profit. The step may include further interim steps such as: Donor/Business partner sets up separate bank account/accounting for the money contributions; Donor/Business implements program and collects donations through round up or direct contribution; and providing Customers with charity donation receipt slips upon request. This process may include a system for redeeming certificates generated by a business partner/donor/merchant retailer redeemable at the cash register or online when “checking out”.

In the next step 430, the corporate donor reports to the Auction Manager the total funds collected with a matching fee component, typically 25%, and then combines the funds collected and the matching component and converts same to certificates. The donor partner then keeps the cash generated from customers that have donated during a purchase transaction, such as when buying groceries or eating at a particular restaurant. In this example, the server asks the diner if they want to donate $1 (or rounding up or adding an additional donation) of their restaurant bill to the charity and the donated funds are collected at that time. Some of the interim steps to 430 may include: Business partner/donor provides weekly report of amount collected; Auction Manager or Donor Partner converts donations into online certificates (or gift cards, etc.) with a coupon code for a one-time certificate redemption; and/or an automated certificate generating process and module.

In step 440, the Donor uses the Auction Manager's (e.g., fundraising facilitator) website to upload the certificates and conduct the auction. This step may also include the step of the Auction Manager uploading instead the converted certificates to a distribution channel (website auction platform and store platform). In step 450, the Auction Manager receives a service fee from the funds received for website sales of the certificates. In step 460, the Auction Manager sends the balance of the proceeds to the selected non-profit or charity. The timing of the program and the disbursements to the non-profit are agreed upon upfront and can change with each program and charity.

In step 470, the buyers of the certificates redeem the certificates at the Donor store or restaurant, thereby creating additional streams of income for the Donor and for increasing marketshare for the Donor. In a related embodiment, a subscription fee may also be included for a shopping site, such as an Overstock.com or Amazon.com, due to volume and constant discount of gift certificates. In related embodiments, the auction system described herein is not necessarily limited to non-profit or charitable fundraising but is also a funds raising vehicle for other business ventures, start-ups, or other ventures requiring the prompt raising of investment funds or capital as an alternative to traditional bank funding or venture capital firms.

In yet another example embodiment, a subscription fee site will be based upon a large amount of gift certificates being collected. The donor partner or participating business and the non-profit may agree to participate in this program and if so the overflow of certificates will be placed on a “Shop for Funds” site, for example. The subscribers in this example embodiment will be alerted that there are certificates available, which certificates may be sold at a discount.

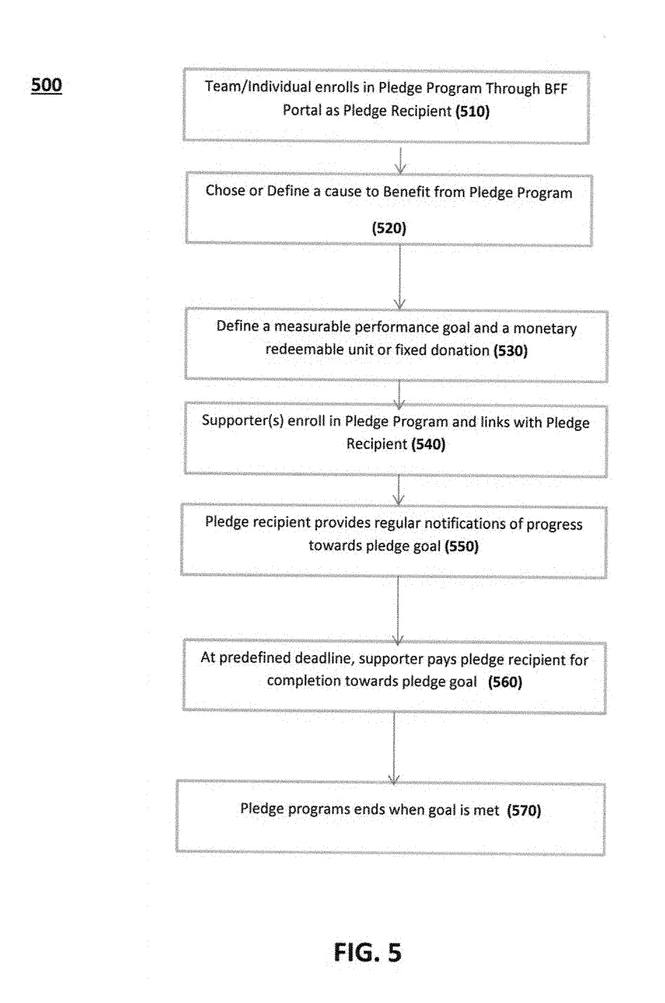

FIG. 5 is flowchart describing a process flow of novel self-defined pledge funding module 500 that is part of a fundraising system (such as system 10) described herein for use in raising funds for the benefit of a third-party cause or nonprofit organization according to the teachings herein. In particular, a computer-implemented method 500 is provided for creating individual fundraising campaigns for a nonprofit organization or cause by a nonprofit member or a nonprofit supporter. The first step 510 in the pledge process is registering a nonprofit organization or defining a cause (step 520) through a fundraising platform such as Pledge for Funds™ (similar or same portal as Bid For Funds™) which has a login module which is communicatively coupled to a pledge module and a nonprofit database hosted by and using a dedicated computer server system as a recipient of funds raised in a fundraising campaign. In steps 510 and 520, a pledge recipient then registers through the login module, the pledge module and the nonprofit database using the dedicated computer server, where the pledge recipient defines the fundraising campaign metrics to include, but not necessarily limited to, a fundraising target, a measurable redeemable unit or a performance goal to be completed by the pledge recipient, optionally a fixed monetary donation for the performance goal completion, an expiration date of the fundraising campaign and a monetary value per redeemable unit completed. The expectation is that upon completion of the performance goal (or a number of measurable monetary redeemable units) by the pledge recipient the supporter or supporters will provide a monetary contribution to the nonprofit on behalf of the pledge recipient.

In step 540 of the process, the supporter or supporters register themselves through the Pledge for Funds website or portal and through the login module, the pledge module and the nonprofit database using the dedicated computer server. At this step, the supporter also inputs payment processing information (such as credit card information in ProPay or Authorize.net, etc.) in a payment processing module enabled by the dedicated computer server. This will facilitate later payments to the nonprofit once the performance goal is reached by the pledge recipient. At this stage, the pledge recipient goes out and starts to meet or beat their stated performance goal: have at least one base hit per game; get 10 points per basketball game; stop 10 hockey shots on goal; achieve 35 yards rushing per high school game, etc. . . . . The measurable units or performance goals are only limited by the mind of the pledge recipient. For non-sport activities, pledge recipients and participants can state other measurable goals: number of books read in a month; number of minutes exercised per day; number of pounds lost; number of food kitchen meals served or delivered, etc. With this program, business partners can still participate but pledge participants need not go door to door to sell items or solicit donations to strangers. This can work within the community of our nonprofit supporters or club or church.

In the next step 550 of the process, the pledge participant notifies their supporters through the dedicated server of the pledge recipient progress towards completing one of either the performance goal or a number of measurable redeemable units (one dollar per hit; or a ten cents per yard rushed in a football game, etc.). In some cases, the supporter can agree to provide a flat monetary donation for the completed activity or at the end of the pledge program. Finally, in step 560, the supporter pays the nonprofit by transmitting to the nonprofit organization or cause, by the dedicated computer server system through the payment processing module, a predefined percentage of funds received from the supporter in connection with the notification of completion of the performance goal or expiration of the individual pledge fundraising campaign. Step 560 usually happens automatically upon receiving notice by the pledge recipient or participant of completion of the performance goal so the supporter does not need to do anything other than follow their son, grandson or granddaughter or co-worker meet their stated goals. In step 570, the pledge program usually ends unless it is extended by the pledge participants and supporters to ensure everyone is still onboard with the continued fundraising campaign.

In a related embodiment, the pledge recipient can also be a nonprofit supporter such as when you as an individual run the marathon and you are also willing to contribute along with the others that have pledged their support to you as the marathon runner on a race to beat cancer, for example. In another related embodiment, merchant retailers and business partners can also get involved as nonprofit supporters by providing redeemable certificates (or gift cards) and merchandise items of at least equal to the value of the completed redeemable units by the pledge recipient to the nonprofit. These redeemable certificates are eventually auctioned off at the fundraiser facilitator's site (e.g., BidForFunds) after which the funds, less a service fee, are credited to the pledge recipient fund which eventually are donated to the designated nonprofit. Finally, the pledge recipient can also receive a fixed donation from a supporter at the completion of the performance goal or expiration of the individual pledge fundraising campaign, which makes it easier and cheaper for the supporter if they are supporting more than one individual or are on a fixed income, such as many participating seniors that may be on fixed incomes.

Referring now to FIGS. 6A-6C, there are illustrated screenshots of a smartphone or smart device exhibiting a fundraising software applet configured to communicate with the fundraising system described herein. In this example embodiment, in connection with FIG. 6A a user is able to use a mobile applet on a smartphone or smart device to log in to one or more of the fundraising systems described herein by first entering an approved user name or email coupled to the user's identity along with a password and type of user (Member, Business Partner or Nonprofit member). In FIG. 6B (Bid An Item), there is displayed an auction screen with various items for sale with Current Values and current Highest Bid that the user can bid on. In FIG. 6C, an actual bid is placed and there is an option to either cancel the transaction (Cancel button) or continue the auction bid (Place your Bid button). Once the bid is placed, the user receives a confirmation of the placed bid and the user needs to return at a later time to find out if the bid was won.

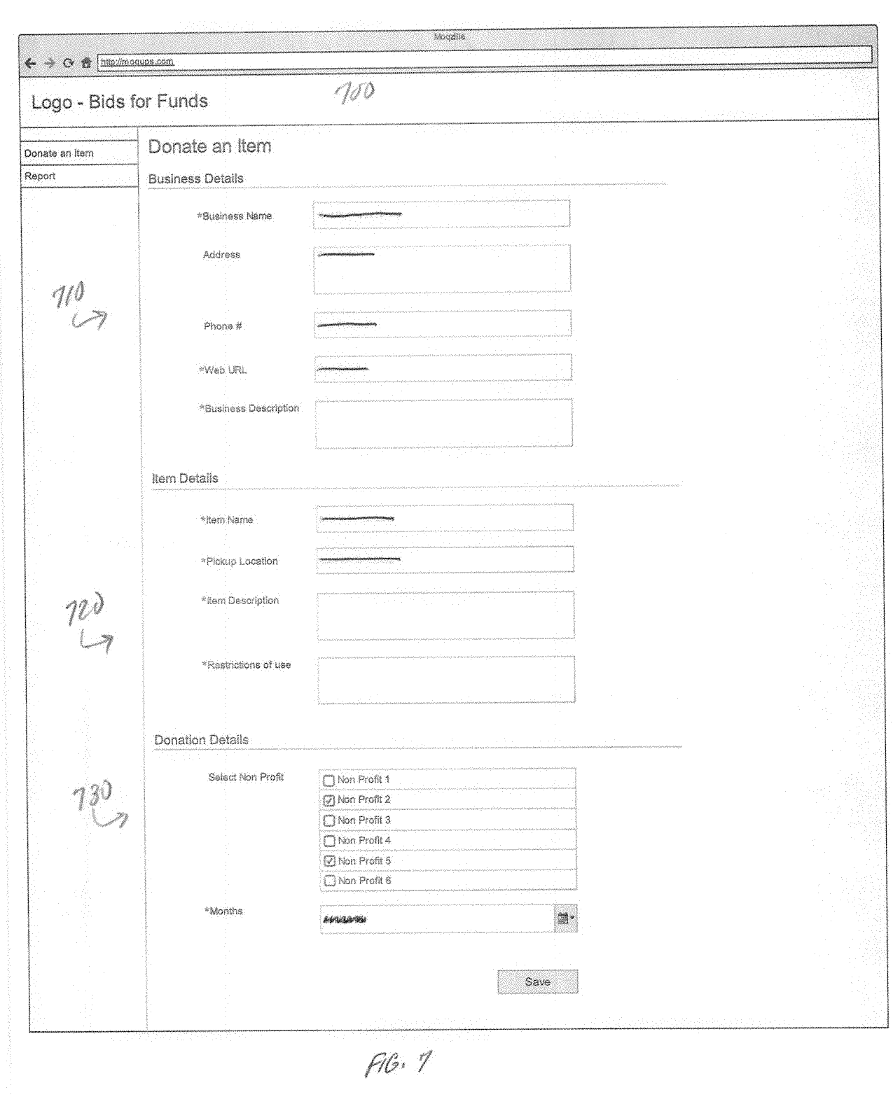

Referring again now to FIGS. 1 and 2 and now to FIG. 7, there is illustrated a screenshot of a business partner's donation page 700 including donated item details and the identification of various nonprofits as potential beneficiaries of the fundraising system described herein. In particular, the business partner enters his contact/identifying information into section 710 to start the donation process. Details of a donated item are then inputted into section 720 of page 700, such as item name, description, restrictions of use and Pickup location. In section 730, the business partner enters details of one or more nonprofits that are available to benefit from the business partner's donation. Before moving from page 700, the business partner can optionally include a time limit for the donation and then the business partner can select “Save” to move forward in the donation process.

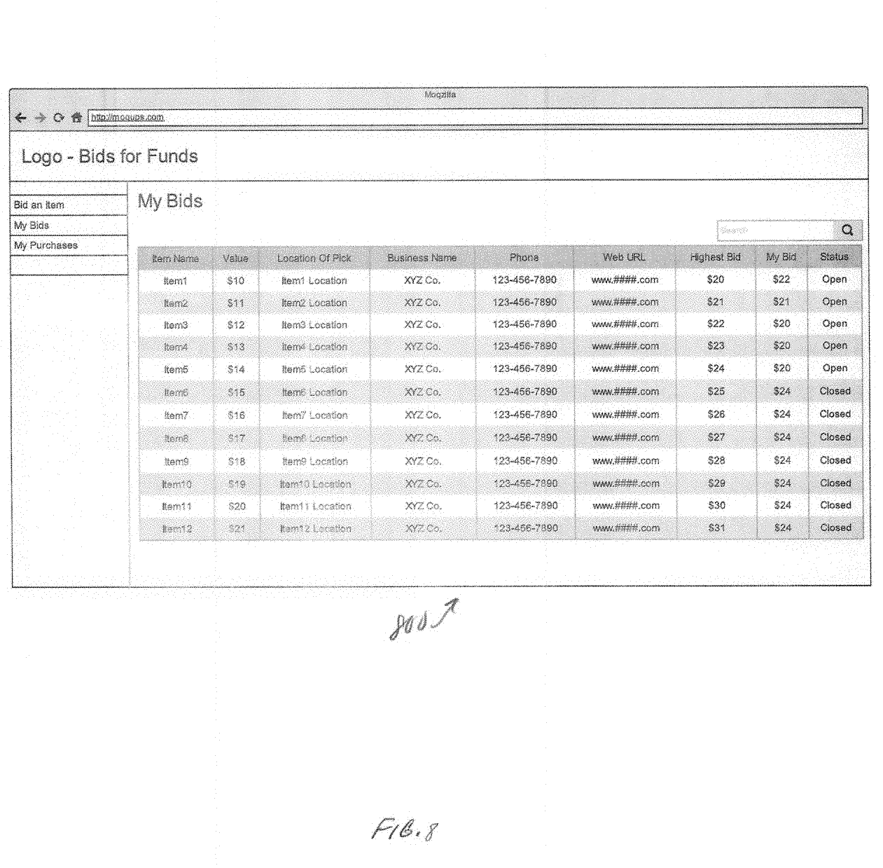

Referring again now to FIGS. 1 and 2 and now to FIG. 8, there is provided a screenshot of a summary of a particular bidder's page 800 on the fundraising system. In particular, page 800 provides information on the User's or Bidder's overall bids as to the item, the value, the Business partner or merchant, the website of the merchant the current Highest Bid, the user's (My Bid) bid and the status of the bid. This provides a useful overall picture of what the user or bidder has active in the system.

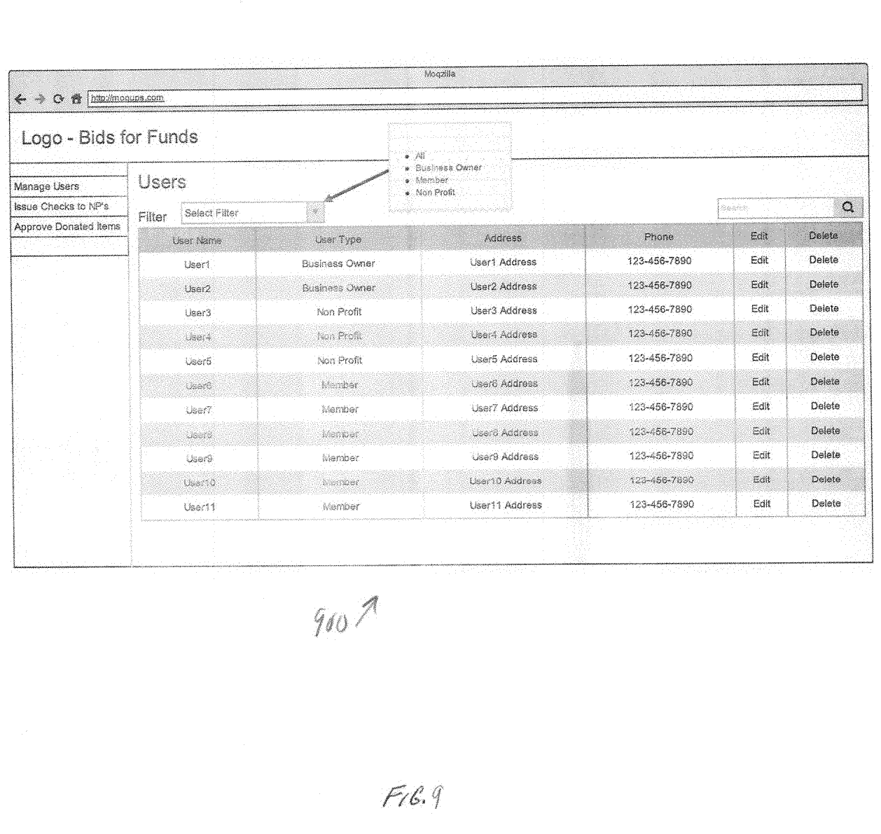

Referring again now to FIGS. 1 and 2 and now to FIG. 9, there is provided a screenshot of Users/Members, Business Partners and Nonprofits page 900 that are active on the fundraising site and system. In particular, the user names, business owners' names, member/bidders names and nonprofit members' names are useful and tracked by an administrator to ensure the fundraising and auction system is operating properly. This also gives the administrator an opportunity to clear out a bid or an auction item if problems in the system arise (such as corrupt bid by another party or donated item details, etc.).

The following patents and publications are herein incorporated by reference in their entireties: U.S. Pat. Nos. 6,112,191; 7,321,876; 7,613,633; 7,970,652; 8,554,571; 8,706,594; 9,076,167 and 9,105,055; and 9,111,300.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

I claim:

1. A computer-implemented method for increasing revenue for a merchant retailer or business partner while participating in a fundraising program for a nonprofit organization or cause, the method comprising:
receiving, at a first computer system, from a plurality of customers a monetary contribution for at least one nonprofit organization, thereby generating a monetary contribution amount from the merchant retailer sponsored fundraising activity for a predefined time period;
providing a matching monetary contribution by the merchant retailer, with the first computer system, of the monetary contribution amount thereby generating a total monetary contribution amount, wherein the matching merchant monetary contribution is a predefined merchant percentage amount of the monetary contribution amount;
receiving by an auction manager, at a second computer system, the total monetary contribution amount from the merchant retailer in the form of redeemable merchant retailer certificates and using the second computer system to post the redeemable certificates on an online auction website hosted by the second computer system, wherein the redeemable certificates comprise predefined individual units of the total monetary contribution amount and are each redeemable with the merchant retailer;
conducting, with the second computer system, an online auction of the redeemable certificates and processing payments by a bidder for the redeemable certificates through a payment processing module enabled by the second computer system;
generating, with the second computer system, a redemption code specific to each merchant retailer redeemable certificate, the redemption code expiring upon one of a first use or a predefined time period; and
transmitting to the nonprofit organization, by the second computer system through the payment processing module, a predefined percentage of funds received from purchases of the redeemable certificates.

2. The method of claim 1, wherein the business partner sponsored activity includes a roundup activity as a process for gathering monetary contributions from the plurality of customers.

3. The method of claim 1, wherein the step of receiving by an auction manager, at a second computer system, the total monetary contribution amount from the merchant retailer also includes using the second computer system to post discounted redeemable certificates on an online website hosted by the second computer system; and
conducting, with the second computer system, an online sale of the discounted redeemable certificates and processing payments by the bidder for the discounted redeemable certificates through the payment processing module enabled by the second computer system.

4. The method of claim 1, further comprising the step of registering the business partner or merchant retailer through the second computer system having a login processing module communicatively coupled to a business partner database.

5. The method of claim 1, further comprising the step of registering the nonprofit organization through the second computer system having a login processing module communicatively coupled to a nonprofit database and to a payment database.

6. The method of claim 1, further comprising the step of registering the bidder through the second computer system having a login processing module communicatively coupled to a user database and a payment database.

7. The method of claim 4, further comprising the step of the business partner designating at least one nonprofit organization through the second computer system as the recipient of funds received from purchases of the redeemable certificates.

8. The method of claim 3, further comprising the step of the business partner designating at least one nonprofit organization through the second computer system as the recipient of funds received from purchases of the discounted redeemable certificates.

9. The method of claim 3, further comprising the step of a second business partner designating at least one nonprofit organization through the second computer system as the recipient of funds received from purchases of the discounted redeemable certificates provided by the first business partner, wherein the second business partner includes a provider of business services.

10. A computer enabled system for increasing revenue for a merchant retailer or business partner while participating in a fundraising program for a nonprofit organization or cause, the system comprising:
a nonprofit database for storing information associated with nonprofit organizations;
a merchant retailer database for storing information associated with a plurality of merchant retailers;
a merchandise database for storing information associated with at least one of: redeemable certificates or merchandise uploaded by a merchant retailer to be sold online via a website hosted on a dedicated computer server system; and a set of redeemable certificates pre-associated with a selected nonprofit having a monetary value that includes a monetary matching component from the merchant retailer;
a redemption code module configured to generate a redemption code specific to each merchant retailer redeemable certificate, the redemption code expiring upon one of a first use or a predefined time period;
a communications module in the dedicated computer server configured to electronically communicate with at least the merchandise and the nonprofit databases and send to a purchaser the information associated with the certificates or merchandise to be sold and the information associated with the nonprofit organization; and
a payment processing module in the dedicated server for receiving, from a purchaser, an offer to purchase the redeemable certificate, or merchandise, and for transmitting a predefined percentage of funds received from purchases of the redeemable certificates to the selected nonprofit organization.

11. The system of claim 10, wherein the merchandise database is configured to receive from the merchant retailer the set of redeemable certificates originating from a the merchant retailer sponsored fundraising activity, wherein the activity includes a roundup activity as a process for gathering monetary contributions from a plurality of customers.

12. The system of claim 10, further comprising an auction module for conducting an online auction with the dedicated server system of the redeemable certificates and processing payments by a bidder for the redeemable certificates through the payment processing module enabled by the dedicated computer server system.

13. The system of claim 10, further comprising a gamification module for generating game-oriented icons with an associated point value embedded randomly in website pages, wherein a cumulative value of the associated points by a participant over a predefined time period leads to participating in a drawing for prizes.

14. The system of claim 10, further comprising a pledge module using the dedicated computer server for generating individual fundraising campaigns for members of the selected nonprofit, wherein the individual fundraising campaign includes: a fundraising target, measurable redeemable units to be completed by a participating nonprofit member, a duration of the fundraising campaign and a process of redeeming the redeemable units with a supporter in exchange for a monetary contribution to the nonprofit.

15. The system of claim 10, further comprising a software applet configured to operate on a portable or mobile smart device and configured to communicate with the communications module of the dedicated computer server, wherein the software applet enables a user to purchase a redeemable certificate and to redeem the certificate from the smart device at the merchant retailer.

16. The system of claim 10, further comprising a store module for displaying to the purchaser discounted merchandise items and redeemable certificates having a discounted “buy it now” price on the website hosted by the dedicated computer server, each of the items and certificates displaying indicia indicating pre-association with a selected nonprofit.

17. A computer-implemented method for creating individual fundraising campaigns for a nonprofit organization or cause by a nonprofit member or a nonprofit supporter, the method comprising:
registering a nonprofit organization or a cause through a login module communicatively coupled to a pledge module and a nonprofit database hosted by and using a dedicated computer server system as a recipient of funds raised in a fundraising campaign;
registering a pledge recipient through the login module, the pledge module and the nonprofit database using the dedicated computer server, wherein the pledge recipient defines the fundraising campaign metrics to include: a fundraising target, a measurable redeemable unit or a performance goal to be completed by the pledge recipient, optionally a fixed monetary donation for the performance goal completion, an expiration date of the fundraising campaign and a monetary value per redeemable unit completed, wherein upon completion of the performance goal at least one supporter provides a monetary contribution to the nonprofit on behalf of the pledge recipient;
registering at least one supporter of the pledge recipient through the login module, the pledge module and the nonprofit database using the dedicated computer server, the supporter inputting payment processing information in a payment processing module enabled by the dedicated computer server;
notifying at least one supporter through the dedicated server of the pledge recipient progress towards completing one of: the performance goal and a number of measurable redeemable units; and
transmitting to the nonprofit organization or cause, by the dedicated computer server system through the payment processing module, a predefined percentage of funds received from the supporter in connection with the notification of completion of the performance goal or expiration of the individual pledge fundraising campaign.

18. The method of claim 17, wherein the pledge recipient is also a nonprofit supporter.

19. The method of claim 17, wherein the nonprofit supporter is a business partner or merchant retailer that provides one of redeemable certificates and merchandise items at least equal to the value of the completed redeemable units by the pledge recipient to the nonprofit.

20. The method of claim 17, wherein the pledge recipient receives a fixed donation from a supporter at the completion of the performance goal or expiration of the individual pledge fundraising campaign.
